(19) United States
(12) Patent Application Publication
(10) Pub. No.: US 2005/0150202 A1
(43) Pub. Date: Jul. 14, 2005

(54) Apparatus and method for monitoring and controlling an agricultural harvesting machine to enhance the economic harvesting performance thereof

(75) Inventor: Graeme R. Quick, Ames, IA (US)

Correspondence Address: ZARLEY LAW FIRM P.L.C., CAPITAL SQUARE, 400 LOCUST, SUITE 200, DES MOINES, IA, 50309-2350, US

(73) Assignee: IOWA STATE UNIVERSITY RESEARCH FOUNDATION, INC., Ames, IA (US)

(21) Appl. No.: 10/879,783

(22) Filed: Jun. 29, 2004

Related U.S. Application Data
(60) Provisional application No. 60/535,014, filed on Jan. 8, 2004.

(51) Int. Cl. A01D 75/28; A01F 12/16

(52) U.S. Cl. 56/10.2 R; 460/1

(57) ABSTRACT

A device is provided for monitoring the economic performance of a machine for harvesting an agricultural product, the device having a plurality of sensors mounted on the machine for detecting operational information about the machine. A controller is provided that is connected to the sensors for receiving the operational information to determine settings for the machine that produce maximum economic return. Means are provided for adjusting settings of the machine either by the operator or by an automatic controller based on the determined settings to achieve maximum economic return. A method for adjusting the settings of an agricultural harvesting machine to produce maximum economic return also is provided.

### CROSS REFERENCE TO RELATED APPLICATIONS

This application is based upon Applicant's U.S. Provisional Patent Application Ser. No. 60/535,014 filed Jan. 8, 2004.

### BACKGROUND OF THE INVENTION

This invention is directed toward an apparatus and method for monitoring and processing information on harvested yield economics and more specifically maximizing economic return from a harvest operation.

Commercial grain harvesting machines are increasingly being utilized to measure many parameters of the crop being harvested. For example, yield monitors and grain moisture sensors are more often fitted as standard equipment on agricultural machines. These sensors are directed toward assisting in determining the harvested yield but do not provide information on the maximum economic return point. More information is needed to determine a grain harvester's optimum economic performance.

The harvest is the crowning act in the season of the grain farming calendar. There is no second chance to recover that grain once the harvester has been through the field—unless it has some (limited) realizable value on the ground as feed for wildlife or livestock.

Most of the grain commodities on the market are graded and priced according to a set of predetermined standards. The USDA, for example, has a grading system for corn that lists five grades, according to such factors as moisture, test weight per bushel, trash in the bin sample, damaged kernels and cracked or foreign material in the samples delivered by the grain producers. Cracked or broken kernels or foreign matter affect the returns received by the farmer and therefore the overall profitability. Combine harvester settings and time in the season are the primary determinants on grain quality at delivery and even have an effect on the ultimate product that is manufactured from the grain. For example, paddy or rough rice will fissure in storage or during drying and cause reduced head rice recovery at the mill if it is damaged during harvest or if the moisture content is sub-optimal at harvest.

An operator is at a disadvantage if he must wait for office bookkeeping, until the grain is delivered to the grain handling authority, or for a sample to be tested elsewhere. These procedures sometimes occur hours or weeks after harvest and before the operator receives quantitative feedback on the dollar value, equity or extent of damage in the crop as it is being harvested. Timely feedback on these issues is particularly critical when viewed in the context of low commodity prices or volatile commodity values on the grain futures market.

In view of these problems, it is the object of this invention to provide a means for a machine controller or an operator to adjust operational settings on the machine as it travels through a field to maintain parameters to keep the combine's econometric performance within a narrow band on either side of its optimum net return. This ensures maximum profitability from the all-important harvest operation.

These and other objectives will be apparent to those skilled in the art.

### BRIEF SUMMARY OF THE INVENTION

The present invention relates to an improvement to crop harvesters or combines that uses sensors in the machine to measure grain yield and integrates this parameter with combine performance parameters and econometrics in such a way as to indicate dollar returns to the operator and simultaneously control functions so that the optimal net return is maintained within a predetermined or acceptable bandwidth setting. The relative or even absolute extent of defined grain quality parameters such as trash, damage, and quality in the field are also computed into the system. The primary application is for grain crops, soybeans, and corn. These are prime examples, but the principles are equally relevant to harvesters, combines, and other agricultural implements for other crops and agricultural products as diverse as cotton, tomatoes and hay.

### BRIEF DESCRIPTION OF THE DRAWINGS

FIG. 1 is a perspective view of a combine of the present invention;

FIG. 2 is a typical graph of the machine harvested yield versus speed of the combine of the present invention;

FIG. 3 is a graph of the harvested return in dollars per acre versus the speed of the combine of the present invention, since dollars per acre is a product of the dollars per bushel and the bushels per acre;

FIG. 4 is a graph of the operating costs versus speed of the combine of the present invention;

FIG. 5 is a graph of the machine harvested yield versus speed of the combine of the present invention while operating at different threshing speeds;

FIG. 6 is a graph of the harvested return in dollars per acre adjusted by the operating costs versus the speed of the combine of the present invention;

FIG. 7 is a graph of machine harvested yield and/or harvested return versus grain damage (i.e. corn); and

FIG. 8 is a flow chart outlining the operation of the combine controller and display system of the present invention.

### DESCRIPTION OF THE PREFERRED EMBODIMENT OF THE INVENTION

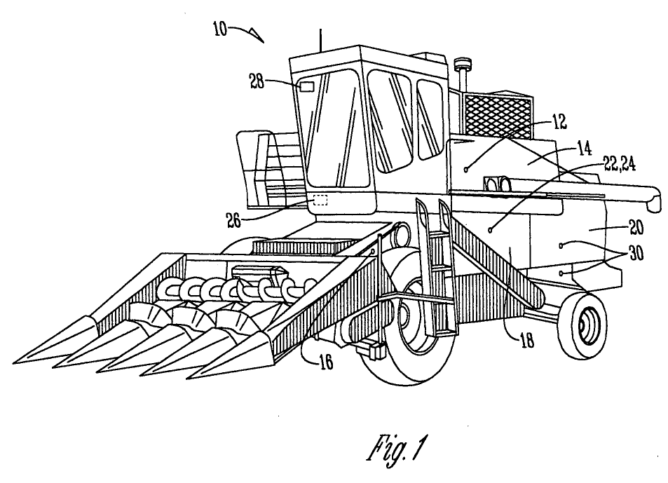

With reference to FIG. 1, the general layout and location of the equipment in this disclosure on a modern combine harvester 10 is shown, as one example of the general application. The present invention includes the integration of a grain yield monitor 12 with certain other sensors known in the art that, when combined with econometric or other predetermined data, can be processed to provide economic information including the optimal economic return.

The yield monitor 12 is usually located in the grain-bin delivery system 14. When installed on the combine 10, the yield monitor 12 may measure: (a) yield as calculated from grain flow rate, as determined by a flow rate sensor 16, and area covered; and (b) the extent of fullness of the gathering head to give a more accurate reading of the capacity of the machine or combine 10 (which, in turn, governs field yield measurement) and field efficiency.

The grain quality measuring devices are located in the clean grain handling section 18 and tailings section 20 of the machine or combine 10. The basic principles of these grain quality sensors are not central to this disclosure. When installed on the combine 10, the grain quality sensors may measure: (a) trash in the clean grain sample stream; (b) crop moisture, as determined by a moisture sensor 22; (c) grain protein and oil; and (d) grain damage, as determined by grain damage monitor 24, including broken grain or splits (for soybeans or other dicots), the degree of grain fractures, both visible and hidden, and the amount of pieces of grain in a sub-sample of the material being conveyed in the combine.

The grain damage monitor 24 can cope with different crops, varieties and field conditions, and may include various sensors, including: (a) simple sifting screens; (b) piezo-electric sounding boards, similar to those employed in grain loss monitors; and (c) fluorescing devices that can assess grain reflectance or infrared detectors, radar or other devices to measure grain parameters and/or the flow-rates of material. Any or all of these sensors may be employed singly or in combination.

Additionally, the combine 10 includes a plurality of sensors monitoring a range of engine and other component service indicators. These sensors may measure the speed of the combine 10, the rotational speed of the engine, the threshing rotor or cylinder speed, and the concave clearance.

The master controller 26 utilizes the signals conditioned from these sensors as inputs to compute, display and maintain machine settings for economic returns. The sensor data is processed by a signal-conditioning unit within the master controller 26 and simplifies the operator's tasks in the field by integrating a wide range of data coming in at any moment, including data from the grain yield monitor 12, the grain quality sensors 22 and 24, and the engine parameter sensors. In particular, however, the controller 26 tells the operator what settings will provide the maximum economic return from the harvest operation in real dollars for the specific crop and condition. The master controller 26 and ancillary equipment are built into or optionally provided as an after-market attachment to the harvester. Preferably, the master controller 26 is incorporated into a control panel (not shown) inside the cab of the combine 10, as indicated by reference numeral 26 in FIG. 1.

After processing, the master controller 26 signals to the operator via an overhead display panel 28 in the cab of the combine 10 and/or automatically controls the harvesting machine or combine 10 to simultaneously measure the important grain quality parameters of the crop and correct the performance of the combine 10 for optimal profitability or economic returns “on-the-go”, or while the combine 10 is operating.

The operator of this “intelligent” machine or combine therefore has two options: (a) the operator can use the information displayed on the display panel 28 to manually change or optimize machine settings to minimize damage and losses, improve grain quality, maximize machine life and, more specifically, to maximize the profit margin or economic returns from the harvest operation of the commodity being harvested; or (b) the operator can allow the “intelligent” machine or combine 10 to take over many of these functions and automatically adjust settings to rectify improper settings and, more importantly, to optimize financial returns from the harvest operation. For example, the operator and/or the combine 10 may vary combine performance parameters such as threshing cylinder speed, concave clearance, combine speed, and rotational engine speed. Additionally, the operator and/or the combine 10 may record data from the engine sensors for subsequent analysis.

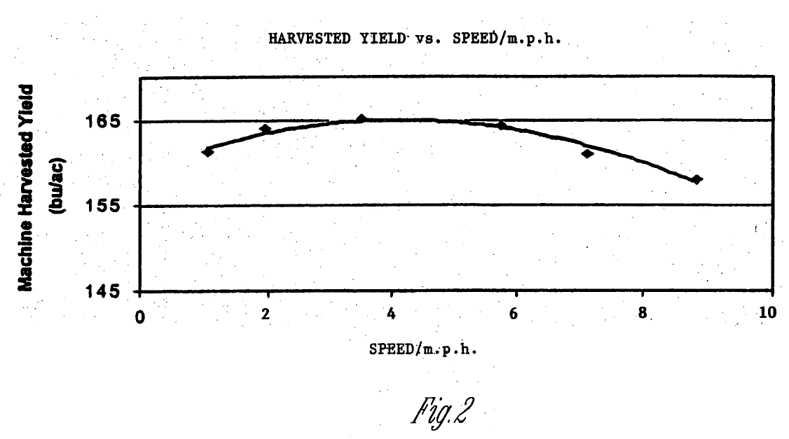

Detailed aspects of the processing of controller 26 are best understood by reference to FIGS. 2-6. The first graph, FIG. 2, shows an example of actual data collected and plotted from combine 10 while operating in a corn field from which numerous data points were collected and the data was manipulated in such a way as to generate actual crop field yield performance in bushels per acre, as plotted against the speed of the combine 10.

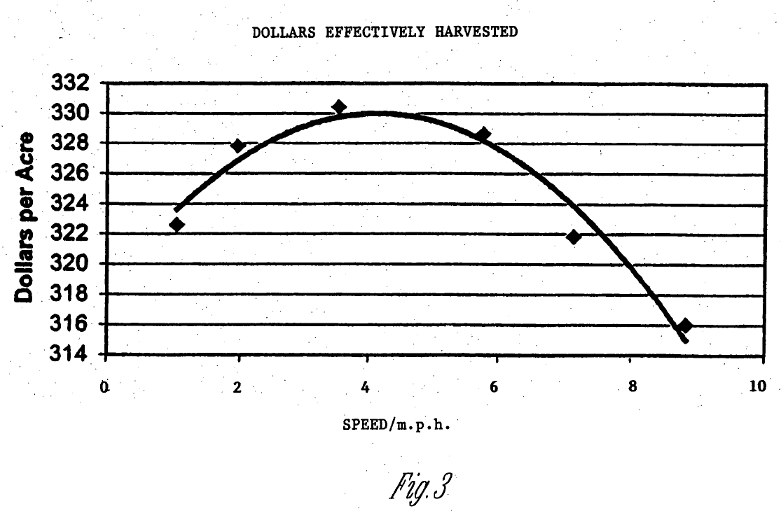

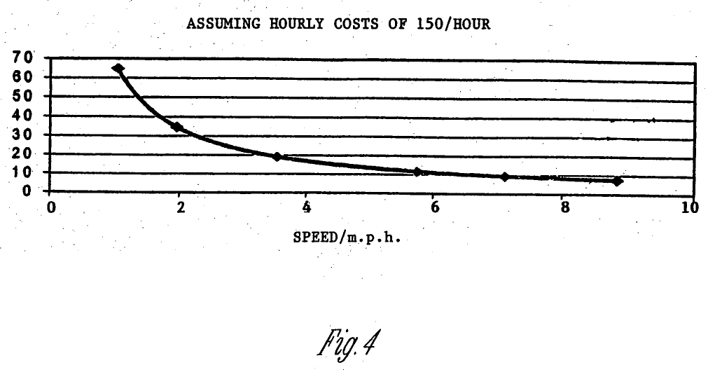

In FIG. 3, this data is transformed into actual dollars returned to the farmer from the field operation, as plotted against the speed of combine 10. The amount of harvested returns displayed in FIG. 3 is further adjusted by the actual ownership and operating (O&O) costs of the particular harvesting machine or combine 10. This predetermined information is inputted by the owner or operator preferably at the beginning of each season or harvest, or when a new crop is to be harvested. An example of the effect of the speed of the combine 10 on O&O costs is shown in FIG. 4. It should be noted that if the harvest is contracted, the O&O costs would be covered by a flat fee per acre, in which case the graph shown in FIG. 4 would be a straight line. For example, the typical custom harvest charge rate for corn grown in the State of Iowa is $20/acre, which includes the O&O costs.

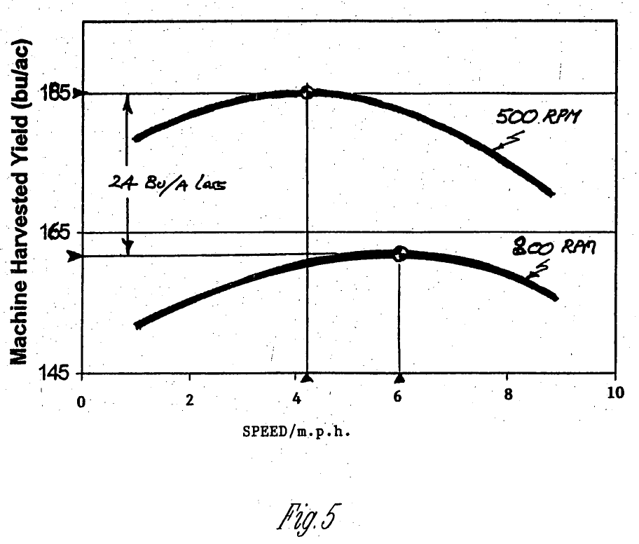

When the O&O costs, as shown in the hyperbolic function of FIG. 4, are considered, the maximum net harvested return is shifted to the right, as shown in FIG. 5. As shown in FIG. 5, the peak of the graph indicates that at about 6 m.p.h., the combine will return the maximum harvested return of $320/acre to the farm. On either side of that optimal harvested return point, the economic returns slide away—by more than $10/acre at the high end, and over $50/acre at the low end. The reasons for the fall-off in economic returns on either side of the optimum point are complex. At the high speed end, grain harvesters or combines 10 are predisposed to high grain losses in the form of grain discharged out the back by the separator and/or the sieves, as determined by grain loss monitors 30. Grain loss also may occur at the gathering head when those processing components have become overloaded.

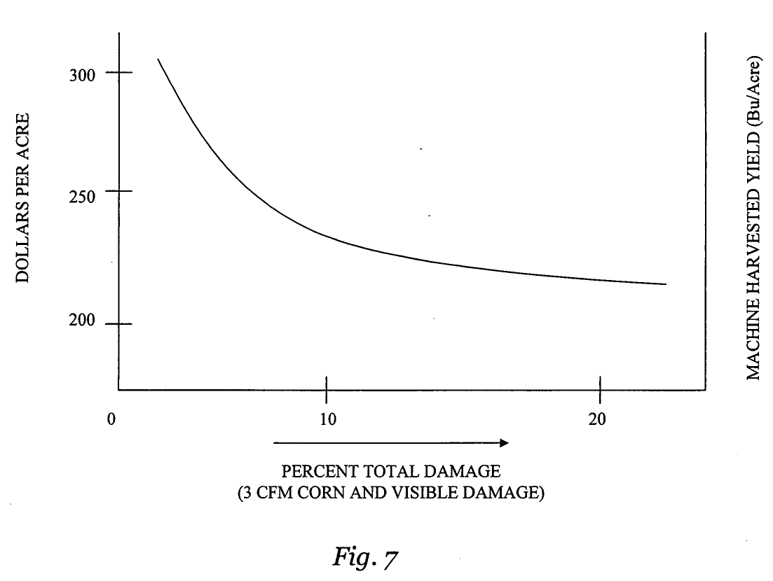

At the low end of the curve, considerable economic value is lost due to time in the field. The reasons for this fall-off at low speeds include: losses due to the processing components being underloaded; losses due to the gathering system, for example, knocking off ears of corn and not traveling fast enough to capture those ears before they fall to the ground, or having sufficient mass of crop material coming in to sweep up the dropped ears or grain; and “invisible losses” due to grain being powdered or pulverized by the lightly-loaded processor, which lacks the cushion of straw to absorb impacts to the ears as they are threshed, with the result that the broken grain particles are blown out the back by the cleaning fan. FIG. 7 shows data from field trials indicating that there is a correlation between machine harvested yield and grain damage. Anything that causes damage reduces harvested yields and profitability. Higher levels of returns of tailings that flow back to the thresher at low throughputs exacerbate the grain damage scenario stated above. In other words, the tailings flow rates increase exponentially the slower the combine 10 is operated. These high tailings flow rates expose the recirculated grain and unthreshed heads in the tailings to secondary or repeated chances of impact damage in the processor, with increased likelihood of powdering the grain. Powdered material will not show up on the grain loss monitors 30, and it is extremely difficult to detect or quantify powdered material with any loss measuring system.

Furthermore, FIG. 5 shows that machine settings cause the economic peak to shift both to a different speed point and to a different recoverable yield level. The powdered grain or head losses are not monitored by present technologies. The measurement of yield on-the-go however is an integrator, taking into account any and all losses by virtue of measuring harvested yield on a unit basis. Finally, an overriding factor at lower speeds is the hyperbolic increase in O&O costs the further the combine 10 is from full capacity.

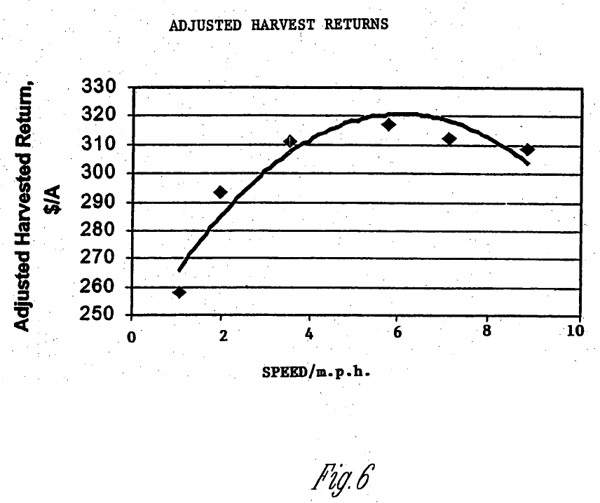

The examples provided illustrate gross and net returns for setup of one machine or combine 10. In FIG. 6, the effects of varying the operational setting of a combine 10 are shown. FIG. 6 shows that the harvested yield is highly sensitive to threshing rotor or cylinder speed. Increasing cylinder or processing rotor speed on the combine 10 enables the combine 10 to process more grain, but at a heavy cost in damage and losses. In the example shown in FIG. 6, the losses amount to twenty-four bushels an acre, which translates at say $2/bushel into almost $50/acre in direct losses. Losses are even more when O&O costs are factored in for net returns. This emphasizes the importance of having a display 28 to show the operator the consequences of harvester mal-adjustment and having a master controller 26 to provide field corrections on-the-go.

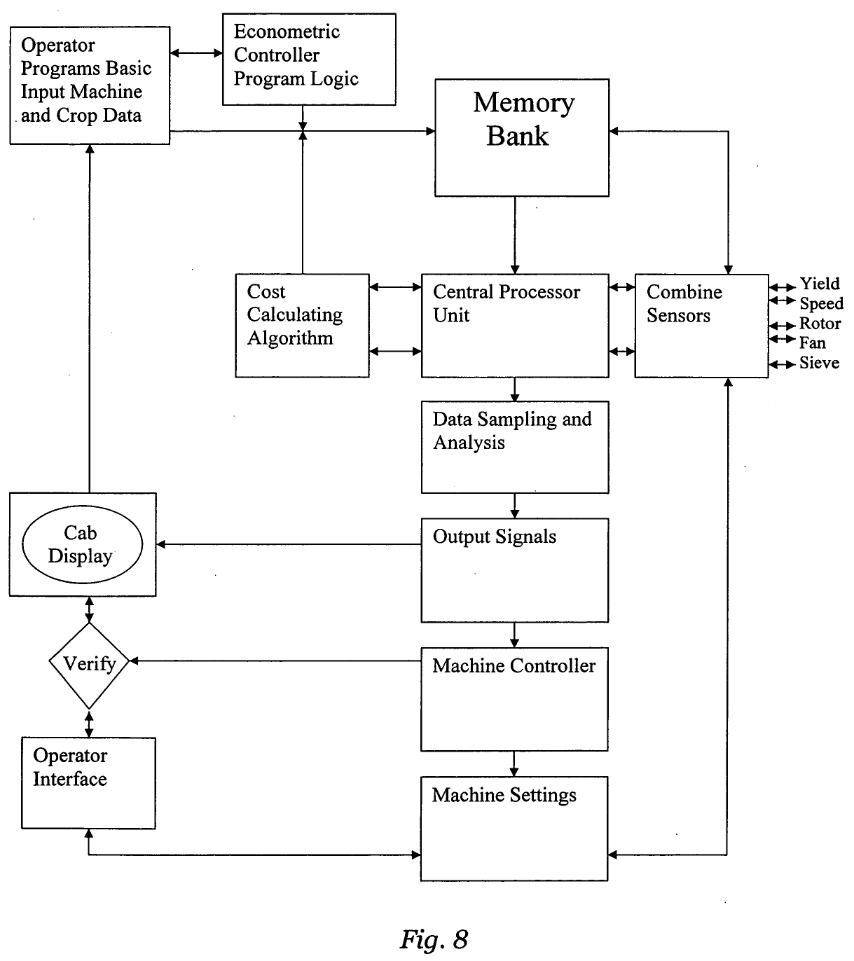

FIG. 8 provides a flow chart that outlines the process of utilizing monitored information for a machine or combine 10 to determine the maximum economic return on the combine's operation. Specifically, prior to operation of the combine 10, the operator programs into the controller 26 certain predetermined O&O costs and economic data. These costs and econometrics, as detailed above in regards to FIG. 3, are saved into a memory bank within controller 26. During operation of the combine 10, the controller 26 receives input from the grain yield monitor 12, the grain quality sensors including the grain moisture sensor 22 and grain damage monitor 24, and the combine and engine performance sensors. The controller 26 applies a cost calculating algorithm to analyze these inputs in consideration of the predetermined O&O costs and econometrics stored in the memory bank of the controller 26. Through analysis of these factors, either the controller 26 or the operator determines the proper adjustment and operation of the combine 10 that will achieve the maximum economic return. The controller 26 displays the proper adjustment and operation settings on the display 28 such that the operator may manipulate the controls of the combine 10 to achieve maximum economic return. Alternatively, the controller 26 automatically adjusts the operation settings of the combine 10 to achieve maximum economic return without the assistance of the operator.

It is therefore seen that by the integration of grain yield, grain quality, and combine performance parameters, as well as predetermined ownership and operating costs, this invention allows a controller to determine the proper adjustment and operation of the combine necessary to achieve the maximum economic return on the combine's operation.

1. A device for monitoring the economic performance of a machine for harvesting an agricultural product comprising:
a plurality of sensors mounted on the machine for detecting operational information about the machine;
a controller connected to the sensors for receiving the operational information to determine settings for the machine that produce maximum economic return; and
a means for adjusting settings of the machine based on the determined settings.

2. The device of claim 1 further comprising a second plurality of sensors on the machine for detecting information about the agricultural product.

3. The device of claim 2 wherein the controller determines settings for the machine based upon the information from the first and second pluralities of sensors.

4. The device of claim 2 wherein the second plurality of sensors detects information about the quality of the agricultural product.

5. The device of claim 2 wherein the second plurality of sensors detects information about the quantity of the agricultural product.

6. The device of claim 1 wherein the controller determines settings for the machine based upon predetermined information stored in the controller.

7. The device of claim 1 wherein the means for adjusting the settings of the machine based on the determined settings are automatically operated.

8. The device of claim 1 wherein the means for adjusting the settings of the machine based on the determined settings are manually operated.

9. A method of adjusting the settings of a machine for harvesting an agricultural product to achieve maximum economic return comprising the steps of:
inputting predetermined information into a controller;
monitoring the machine to obtain operational information;
processing the predetermined information and the operational information to determine settings that produce maximum economic return; and
adjusting the machine settings based on the determined settings.

10. The method of claim 9 further comprising monitoring the agricultural product to obtain agricultural product information.

11. The method of claim 10 wherein the determined settings are based upon the predetermined information, the operational information, and the agricultural product information.

12. The method of claim 10 wherein the agricultural product information relates to the quality of the agricultural product.

13. The method of claim 10 wherein the agricultural product information relates to the quantity of the agricultural product.

14. The method of claim 9, wherein the predetermined information includes econometric data.

15. The device of claim 1 further comprising a means for supplying econometric data of the agricultural product, the controller connected to the means for supplying econometric data, the controller receives the operational information and the econometric data to determine settings for the machine that produce maximum economic return.
